(19) United States
(12) Patent Application Publication
(10) Pub. No.: US 2005/0219374 A1
(43) Pub. Date: Oct. 6, 2005

(54) Photographing apparatus

(75) Inventor: Yukio Uenaka, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/088,778

(22) Filed: Mar. 25, 2005

(30) Foreign Application Priority Data
Mar. 30, 2004 (JP) P2004-097837

(51) Int. Cl. H04N 5/228; G03B 17/00

(52) U.S. Cl. 348/208.12; 348/208.2

(57) ABSTRACT

A photographing apparatus comprises a detecting unit and an indicating unit. The detecting unit performs a detecting operation to detect a first quantity of a hand-shake of the photographing apparatus in a first direction, and to detect a second quantity of the hand-shake in a second direction. The first direction is perpendicular to an optical axis of a photographing lens of the photographing apparatus. The second direction is perpendicular to the optical axis and the first direction. The indicating unit performs an indicating operation to indicate the first and second quantities.

### BACKGROUND OF THE INVENTION

1. Field of the Invention

The present invention relates to a portable apparatus such as binoculars or a photographing apparatus and in particular to an indicating apparatus for a hand-shake quantity.

2. Description of the Related Art

A photographing apparatus which indicates a hand-shake quantity occurring in imaging operation, is proposed. By indicating the hand-shake quantity, the operator can recognize the hand-shake quantity.

Japanese unexamined patent publication (KOKAI) No. 2000-314915 discloses an apparatus which indicates a hand-shake quantity. The apparatus indicates a hand-shake quantity in one dimension.

However, the operator can not recognize the hand-shake quantity of the horizontal direction and the hand-shake quantity of the vertical direction, separately.

### SUMMARY OF THE INVENTION

Therefore, an object of the present invention is to provide an apparatus in which the hand-shake quantity can be recognized in every direction.

According to the present invention, a portable apparatus comprises a detecting unit and an indicating unit.

The detecting unit performs a detecting operation to detect a first quantity of a hand-shake of the portable apparatus in a first direction, and to detect a second quantity of the hand-shake in a second direction.

The first direction is perpendicular to an optical axis of an optical system of the photographing apparatus. The second direction is perpendicular to the optical axis and the first direction.

The indicating unit performs an indicating operation to indicate the first and second quantities.

### BRIEF DESCRIPTION OF THE DRAWINGS

The objects and advantages of the present invention will be better understood from the following description, with reference to the accompanying drawings in which:

FIG. 1 is a perspective view of a photographing apparatus of the embodiments, viewed from the back side of the photographing apparatus;

FIG. 2 is a front view of the photographing apparatus;

FIG. 3 is a circuit construction diagram of the photographing apparatus;

FIG. 4 is a figure showing the construction of the anti-shake unit;

FIG. 5 is a view along line A-A of FIG. 4;

FIG. 6 is a first graph which shows a relationship between the time and the hand-shake quantity of the photographing apparatus, in the case that the first time-length is shorter than the second time-length, in the first embodiment;

FIG. 7 is the first graph which shows a relationship between the time and the hand-shake quantity of the photographing apparatus, in the case that the first time-length is the same as the second time-length, in the first embodiment;

FIG. 8 is the first graph which shows a relationship between the time and the hand-shake quantity of the photographing apparatus, in the case that the first time-length is longer than the second time-length, in the first embodiment;

FIG. 9 is an indicating pattern of the first graph and the image;

FIG. 10 is a flowchart of the anti-shake operation, which is performed at every first time-interval, as an interruption process;

FIG. 11 is a flowchart of the imaging operation;

FIG. 12 is a flowchart of the indication of the first graph.

FIG. 13 is a second graph which shows a relationship between the time and the hand-shake quantity of the photographing apparatus, in the second embodiment; and

FIG. 14 is third and fourth graphs which show a relationship between the time and the hand-shake quantity of the photographing apparatus, in the third embodiment.

### DESCRIPTION OF THE PREFERRED EMBODIMENTS

The present invention is described below with reference to the embodiment shown in the drawings. In the first, second, and third embodiments, the photographing apparatus 1 is a digital camera. The photographing apparatus 1 has an optical axis LX.

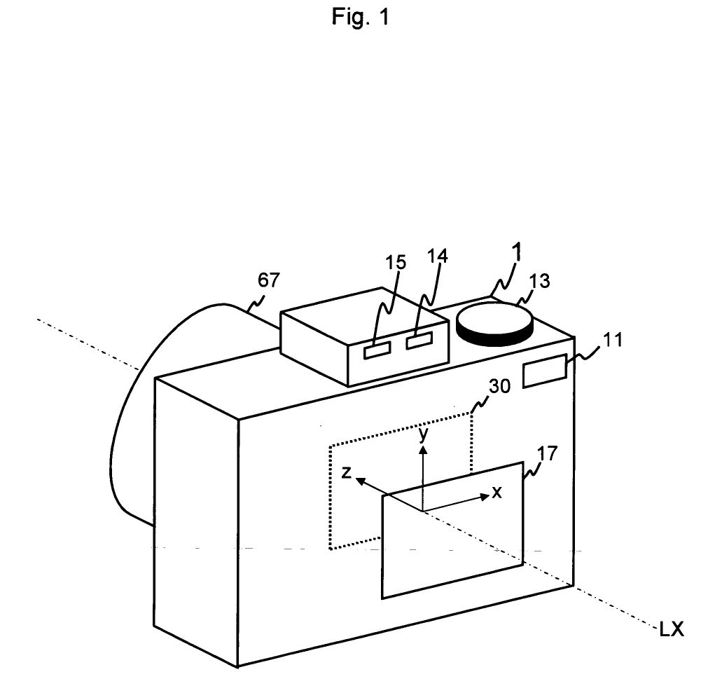

In order to explain the direction in this embodiment, a first direction x, a second direction y, and a third direction z are defined (see FIG. 1). The first direction x is a horizontal direction which is perpendicular to the optical axis LX. The second direction y is a vertical direction which is perpendicular to the optical axis LX and the first direction x. The third direction z is a horizontal direction which is parallel to the optical axis LX and perpendicular to both the first direction x and the second direction y.

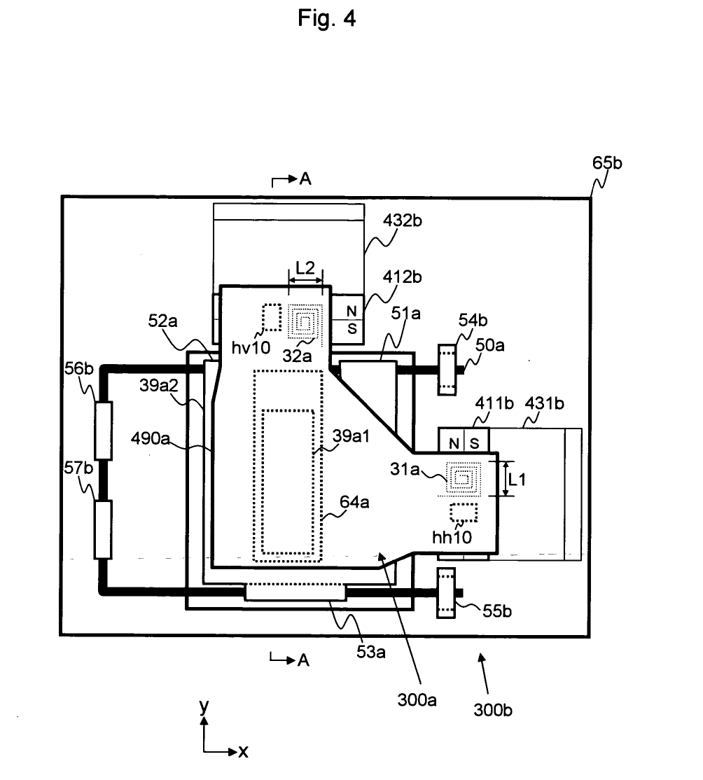

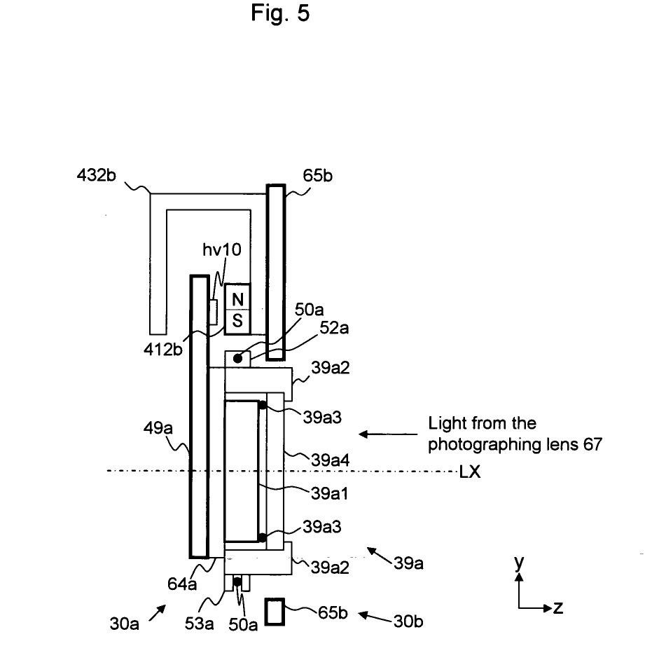

FIG. 5 shows a construction diagram of the section along line A-A of FIG. 4.

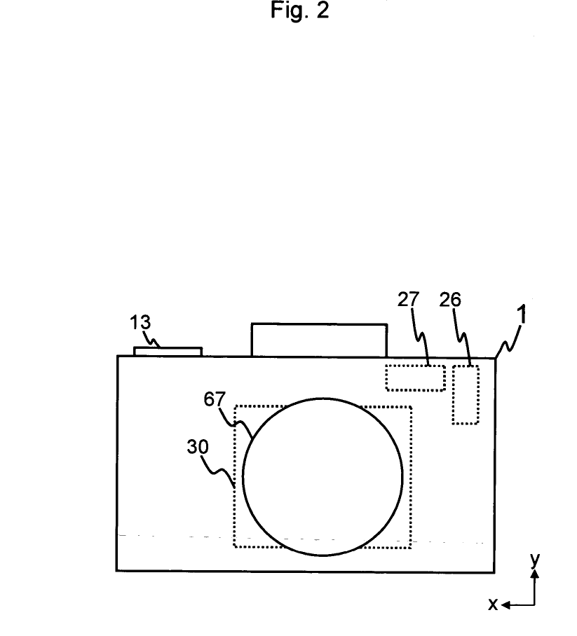

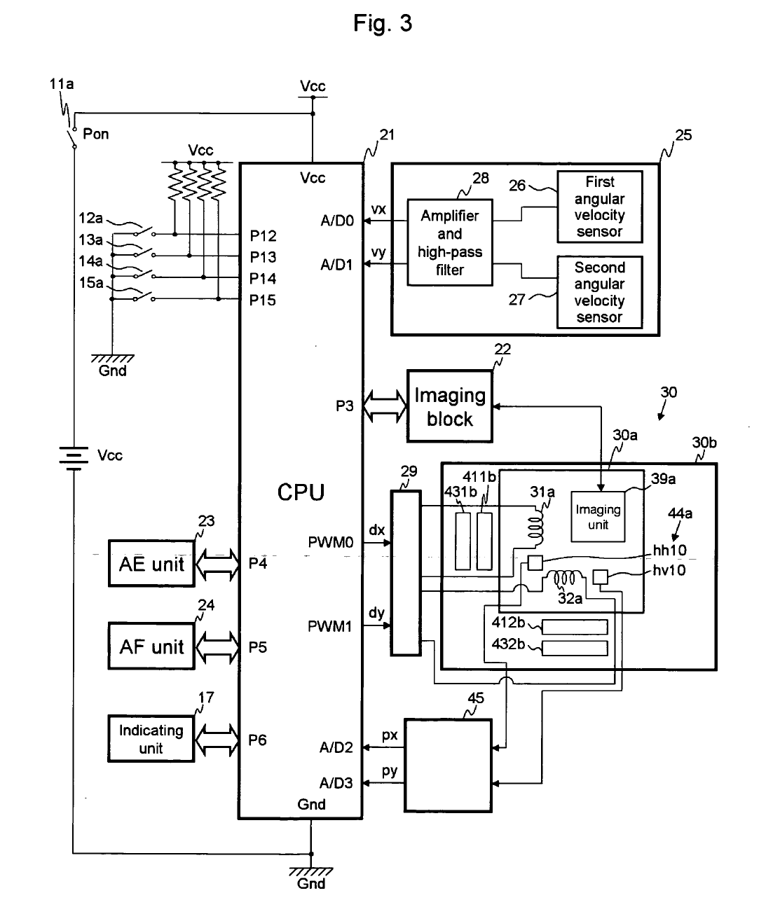

The imaging part of the photographing apparatus 1 comprises a Pon button 11, a Pon switch 11a, a photometric switch 12a, a release button 13, a release switch 13a, an indicating unit 17 such as an LCD monitor etc., a CPU 21, an imaging block 22, an AE (automatic exposure) unit 23, an AF (automatic focusing) unit 24, an imaging unit 39a in the anti-shake unit 30, and a photographing lens 67 (see FIGS. 1, 2, and 3).

Whether the Pon switch 11a is in the on state or the off state, is determined by a state of the Pon button 11, so that the ON/OFF states of the main power supply of the photographing apparatus 1 are changed corresponding to the ON/OFF states of the Pon switch 11a.

The photographic subject image is taken as an optical image through the photographing lens 67 by the imaging block 22, which drives the imaging unit 39a, so that the image, which is taken, is indicated on the indicating unit 17. The photographic subject image can be optically observed by the optical finder (not depicted).

When the release button 13 is half pushed by the operator, the photometric switch 12a changes to the on state, so that the photometric operation, the AF sensing operation, and the focusing operation are performed.

When the release button 13 is fully pushed by the operator, the release switch 13a changes to the on state, so that the imaging operation is performed, and the image, which is taken, is stored.

The CPU 21 is a control apparatus, which controls each part of the photographing apparatus 1 regarding the imaging operation, and controls each part of the photographing apparatus 1 regarding the anti-shake operation. The anti-shake operation controls the movement of the movable unit 30a and controls detecting the position of the movable unit 30a.

The imaging block 22 drives the imaging unit 39a. The AE unit 23 performs the photometric operation for the photographic subject, calculates the photometric values, and calculates the aperture value and the time length of the exposure time, which is needed for imaging, corresponding to the photometric values. The AF unit 24 performs the AF sensing operation, and performs the focusing operation, which is needed for the imaging, corresponding to the result of the AF sensing operation. In the focusing operation, the position of the photographing lens 67 is moved in the optical axis LX direction.

The anti-shaking part of the photographing apparatus 1 comprises an anti-shake button 14, an anti-shake switch 14a, a hand-shake indicating-mode button 15, a hand-shake indicating-mode switch 15a, an indicating unit 17, a CPU 21, an angular velocity detecting unit 25, a driver circuit 29, an anti-shake unit 30, a hall-element signal-processing unit 45, and the photographing lens 67.

When the anti-shake button 14 is fully pushed by the operator, the anti-shake switch 14a changes to the on state, so that the anti-shake operation is performed where the angular velocity detecting unit 25 and the anti-shake unit 30 are driven, at every first time-interval, independently of the other operations which include the photometric operation etc. In the first embodiment, the first time-interval is 1 ms.

When the hand-shake indicating-mode button 15 is fully pushed by the operator, the hand-shake indicating-mode switch 15a changes to the on state, so that the hand-shake quantity is indicated on the indicating unit 17. When the hand-shake indicating-mode switch 15a is in the on state, in other words in the hand-shake indicating-mode, the parameter DISP is set to 1 (DISP=1). When the hand-shake indicating-mode switch 15a is not in the on state, in other words in the non hand-shake indicating-mode, the parameter DISP is set to 0 (DISP=0). The value of the parameter DISP is stored in the CPU 21 etc.

The various output commands corresponding to the input signals of these switches are controlled by the CPU 21.

The information regarding whether the photometric switch 12a is in the on state or in the off state, is input to port P12 of the CPU 21 as a 1-bit digital signal. The information regarding whether the release switch 13a is in the on state or in the off state, is input to port P13 of the CPU 21 as a 1-bit digital signal. The information regarding whether the anti-shake switch 14a is in the on state or in the off state, is input to port P14 of the CPU 21 as a 1-bit digital signal. The information regarding whether the photometric switch 15a is in the on state or in the off state, is input to port P15 of the CPU 21 as a 1-bit digital signal.

The imaging block 22 is connected to port P3 of the CPU 21 for inputting and outputting signals. The AE unit 23 is connected to port P4 of the CPU 21 for inputting and outputting signals. The AF unit 24 is connected to port P5 of the CPU 21 for inputting and outputting signals. The indicating unit 17 is connected to port P6 of the CPU 21 for inputting and outputting signals.

Next, the details of the input and output relationship with the CPU 21 for the angular velocity unit 25, the driver circuit 29, the anti-shake unit 30, and the hall-element signal-processing unit 45 are explained.

The angular velocity unit 25 has a first angular velocity sensor 26, a second angular velocity sensor 27, and a combined amplifier and high-pass filter circuit 28. The first angular velocity sensor 26 detects the velocity-component in the first direction x of the angular velocity of the photographing apparatus 1, at every first time-interval (1 ms), for detecting the hand-shake quantity. The second angular velocity sensor 27 detects the velocity-component in the second direction y of the angular velocity of the photographing apparatus 1, at every first time-interval (1 ms), for detecting the hand-shake quantity.

The combined amplifier and high-pass filter circuit 28 amplifies the signal regarding the first direction x of the angular velocity (the velocity-component in the first direction x of the angular velocity), reduces a null voltage and a panning of the first angular velocity sensor 26, and outputs the analogue signal to the A/D converter A/D 0 of the CPU 21 as a first angular velocity vx.

The combined amplifier and high-pass filter circuit 28 amplifies the signal regarding the second direction y of the angular velocity (the velocity-component in the second direction y of the angular velocity), reduces a null voltage and a panning of the second angular velocity sensor 27, and outputs the analogue signal to the A/D converter A/D 1 of the CPU 21 as a second angular velocity vy.

The CPU 21 converts the first angular velocity vx which is input to the A/D converter A/D 0 and the second angular velocity vy which is input to the A/D converter A/D 1, to digital signals (A/D converting operation), and calculates the hand-shake quantity, which occurs in the first time-interval (1 ms), on the basis of the converted digital signals and the converting coefficient, where focal distance is considered. Accordingly, the CPU 21 and the angular velocity detecting unit 25 have a function which calculates the hand-shake quantity.

The CPU 21 calculates the position S of the imaging unit 39a (the movable unit 30a), which should be moved to, corresponding to the hand-shake quantity which is calculated, for the first direction x and the second direction y.

The location in the first direction x of the position S is defined as sx, and the location in the second direction y of the position S is defined as sy. The movement of the movable unit 30a, which includes the imaging unit 39a, is performed by using electro-magnetic force and is described later. The driving force D, which drives the driver circuit 29 in order to move the movable unit 30a to the position S, has a first PWM duty dx as the driving-force component in the first direction x, and a second PWM duty dy as the driving-force component in the second direction y.

The anti-shake unit 30 is an apparatus which corrects the hand-shake effect, by moving the imaging unit 39a to the position S, by canceling lag of the photographic subject image on the imaging surface of the imaging device 39a1, and by stabilizing the photographing subject image that reaches the imaging surface of the imaging device 39a1.

The anti-shake unit 30 has a movable unit 30a, which includes the imaging unit 39a, and a fixed unit 30b. Or, the anti-shake unit 30 is composed of a driving part which moves the movable unit 30a by electro-magnetic force to the position S, and a position-detecting part which detects the position of the movable unit 30a (a detected-position P).

The size and the direction of the electro-magnetic force are determined by the size and the direction of the current which flows in the coil, and the size and the direction of the magnetic-field of the magnet.

The driving of the movable unit 30a of the anti-shake unit 30, is performed by the driver circuit 29 which has the first PWM duty dx input from the PWM 0 of the CPU 21 and has the second PWM duty dy input from the PWM 1 of the CPU 21. The detected-position P of the movable unit 30a, either before moving or after moving, which is moved by driving the driver circuit 29, is detected by the hall element unit 44a and the hall-element signal-processing unit 45.

Information of a first location in the first direction x for the detected-position P, in other words a first detected-position signal px is input to the A/D converter A/D 2 of the CPU 21. The first detected-position signal px is an analogue signal, and is converted to a digital signal through the A/D converter A/D 2 (A/D converting operation). The first location in the first direction x for the detected-position P, after the A/D converting operation, is defined as pdx, corresponding to the first detected-position signal px.

Information of a second location in the second direction y for the detected-position P, in other words a second detected-position signal py is input to the A/D converter A/D 3 of the CPU 21. The second detected-position signal py is an analogue signal, and is converted to a digital signal through the A/D converter A/D 3 (A/D converting operation). The second location in the second direction y for the detected-position P, after the A/D converting operation, is defined as pdy, corresponding to the second detected-position signal py.

The PID (Proportional Integral Differential) control is performed on the basis of the data for the detected-position P (pdx, pdy) and the data for the position S (sx, sy) which should be moved to.

The movable unit 30a has a first driving coil 31a, a second driving coil 32a, an imaging unit 39a, a hall element unit 44a, a movable circuit board 49a, a shaft for movement 50a, a first bearing unit for horizontal movement 51a, a second bearing unit for horizontal movement 52a, a third bearing unit for horizontal movement 53a, and a plate 64a (see FIGS. 4 and 5).

The fixed unit 30b has a position-detecting magnet unit, a first position-detecting and driving yoke 431b, a second position-detecting and driving yoke 432b, a first bearing unit for vertical movement 54b, a second bearing unit for vertical movement 55b, a third bearing unit for vertical movement 56b, a fourth bearing unit for vertical movement 57b, and a base board 65b. The position-detecting magnet unit has a first position-detecting and driving magnet 411b and a second position-detecting and driving magnet 412b.

The shaft for movement 50a of the movable unit 30a has a channel shape when viewed from the third direction z. The first, second, third, and fourth bearing units for vertical movement 54b, 55b, 56b, and 57b are attached to the base board 65b of the fixed unit 30b. The shaft for movement 50a is slidably supported in the vertical direction (the second direction y), by the first, second, third, and fourth bearing units for vertical movement 54b, 55b, 56b, and 57b.

The first and second bearing units for vertical movement 54b and 55b have slots which extend in the second direction y.

Therefore, the movable unit 30a can move relative to the fixed unit 30b, in the vertical direction (the second direction y).

The shaft for movement 50a is slidably supported in the horizontal direction (the first direction x), by the first, second, and third bearing units for horizontal movement 51a, 52a, and 53a of the movable unit 30a. Therefore, the movable unit 30a, except for the shaft for movement 50a, can move relative to the fixed unit 30b and the shaft for movement 50a, in the horizontal direction (the first direction x).

When the center area of the imaging device 39a1 is located on the optical axis LX of the photographing lens 67, the location relation between the movable unit 30a and the fixed unit 30b is set up so that the movable unit 30a is located at the center of its movement range in both the first direction x and the second direction y, in order to utilize the full size of the imaging range of the imaging device 39a1.

A rectangle shape, which forms the imaging surface (the valid pixel area) of the imaging device 39a1, has two diagonal lines. In the first embodiment, the center of the imaging device 39a1 is the crossing point of these two diagonal lines.

In the first embodiment, the center of the imaging device 39a1 agrees with the center of gravity of the rectangle shape of the valid pixel area. Accordingly, when the movable unit 30a is located at the center of its movement range, the center of gravity of the rectangle shape of the valid pixel area is located on the optical axis LX of the photographing lens 67.

The imaging unit 39a, the plate 64a, and the movable circuit board 49a are attached, in this order along the optical axis LX direction, viewed from the side of the photographing lens 67. The imaging unit 39a has an imaging device 39a1 (such as a CCD or a COMS etc.), a stage 39a2, a holding unit 39a3, and an optical low-pass filter 39a4. The stage 39a2 and the plate 64a hold and urge the imaging device 39a1, the holding unit 39a3, and the optical low-pass filter 39a4 in the optical axis LX direction.

The first, second, and third bearing units for horizontal movement 51a, 52a, and 53a are attached to the stage 39a2. The imaging device 39a1 is attached to the plate 64a, so that positioning of the imaging device 39a1 is performed where the imaging device 39a1 is perpendicular to the optical axis LX of the photographing lens 67. In the case where the plate 64a is made of a metallic material, the plate 64a has the effect of radiating heat from the imaging device 39a1, by contacting the imaging device 39a1.

The first driving coil 31a, the second driving coil 32a, and the hall element unit 44a are attached to the movable circuit board 49a.

The first driving coil 31a forms a seat and a spiral shape coil pattern. The coil pattern of the first driving coil 31a has lines which are parallel to either the first direction x or the second direction y, where the movable unit 30a which includes the first driving coil 31a, is moved in the first direction x, by the first electro-magnetic force. The lines which are parallel to the second direction y, are used for moving the movable unit 30a in the first direction x. The lines which are parallel to the second direction y, have a first effective length L1.

The first electro-magnetic force occurs on the basis of the current direction of the first driving coil 31a and the magnetic-field direction of the first position-detecting and driving magnet 411b.

The second driving coil 32a forms a seat and a spiral shape coil pattern. The coil pattern of the second driving coil 32a has lines which are parallel to either the first direction x or the second direction y, where the movable unit 30a which includes the second driving coil 32a, is moved in the second direction y, by the second electro-magnetic force. The lines which are parallel to the first direction x, are used for moving the movable unit 30a in the second direction y. The lines which are parallel to the first direction x, have a second effective length L2.

The second electro-magnetic force occurs on the basis of the current direction of the second driving coil 32a and the magnetic-field direction of the second position-detecting and driving magnet 412b.

The first and second driving coils 31a and 32a are connected with the driver circuit 29 which drives the first and second driving coils 31a and 32a through the flexible circuit board (not depicted). The first PWM duty dx is input to the driver circuit 29 from the PWM 0 of the CPU 21, and the second PWM duty dy is input to the driver circuit 29 from the PWM 1 of the CPU 21. The driver circuit 29 supplies power to the first driving coil 31a corresponding to the value of the first PWM duty dx, and to the second driving coil 32a corresponding to the value of the second PWM duty dy, to drive the movable unit 30a.

The first position-detecting and driving magnet 411b is attached to the movable unit side of the fixed unit 30b, where the first position-detecting and driving magnet 411b faces the first driving coil 31a and the horizontal hall element hh10 in the third direction z.

The second position-detecting and driving magnet 412b is attached to the movable unit side of the fixed unit 30b, where the second position-detecting and driving magnet 412b faces the second driving coil 32a and the vertical hall element hv10 in the third direction z.

The first position-detecting and driving magnet 411b is attached to the first position-detecting and driving yoke 431b, under the condition where the N pole and S pole are arranged in the first direction x. The first position-detecting and driving yoke 431b is attached to the base board 65b of the fixed unit 30b, on the side of the movable unit 30a, in the third direction z.

The length of the first position-detecting and driving magnet 411b in the second direction y, is longer in comparison with the first effective length L1 of the first driving coil 31a. The magnetic-field which influences the first driving coil 31a and the horizontal hall element hh10, is not changed during movement of the movable unit 30a in the second direction y.

The second position-detecting and driving magnet 412b is attached to the second position-detecting and driving yoke 432b, under the condition where the N pole and S pole are arranged in the second direction y. The second position-detecting and driving yoke 432b is attached to the base board 65b of the fixed unit 30b, on the side of the movable unit 30a, in the third direction z.

The length of the second position-detecting and driving magnet 412b in the first direction x, is longer in comparison with the second effective length L2 of the second driving coil 32a. The magnetic-field which influences the second driving coil 32a and the vertical hall element hv10, is not changed during movement of the movable unit 30a in the first direction x.

The first position-detecting and driving yoke 431b is made of a soft magnetic material, and forms a square-u-shape channel when viewed from the second direction y. The first position-detecting and driving magnet 411b, the first driving coil 31a, and the horizontal hall element hh10 are inside the channel of the first position-detecting and driving yoke 431b.

The side of the first position-detecting and driving yoke 431b, which contacts the first position-detecting and driving magnet 411b, prevents the magnetic-field of the first position-detecting and driving magnet 411b from leaking to the surroundings.

The other side of the first position-detecting and driving yoke 431b (which faces the first position-detecting and driving magnet 411b, the first driving coil 31a, and the movable circuit board 49a) raises the magnetic-flux density between the first position-detecting and driving magnet 411b and the first driving coil 31a, and between the first position-detecting and driving magnet 411b and the horizontal hall element hh10.

The second position-detecting and driving yoke 432b is made of a soft magnetic material, and forms a square-u-shape channel when viewed from the first direction x. The second position-detecting and driving magnet 412b, the second driving coil 32a, and the vertical hall element hv10 are inside the channel of the second position-detecting and driving yoke 432b.

The side of the second position-detecting and driving yoke 432b, which contacts the second position-detecting and driving magnet 412b, prevents the magnetic-field of the second position-detecting and driving magnet 412b from leaking to the surroundings.

The other side of the second position-detecting and driving yoke 432b (which faces the second position-detecting and driving magnet 412b, the second driving coil 32a, and the movable circuit board 49a) raises the magnetic-flux density between the second position-detecting and driving magnet 412b and the second driving coil 32a, and between the second position-detecting and driving magnet 412b and the vertical hall element hv10.

The hall element unit 44a is a one-axis hall element which has two hall elements that are magnetoelectric converting elements (magnetic-field change-detecting elements) using the Hall Effect. The hall element unit 44a detects the first detected-position signal px which is used for specifying the first location in the first direction x for the present position P of the movable unit 30a, and the second detected-position signal py which is used for specifying the second location in the second direction y for the present position P of the movable unit 30a.

One of the two hall elements is a horizontal hall element hh10 for detecting the first location in the first direction x of the movable unit 30a, so that the other is a vertical hall element hv10 for detecting the second location in the second direction y of the movable unit 30a (see FIG. 4).

The horizontal hall element hh10 is attached to the movable circuit board 49a of the movable unit 30a, under the condition where the horizontal hall element hh10 faces the first position-detecting and driving magnet 411b of the fixed unit 30b, in the third direction z.

The vertical hall element hv10 is attached to the movable circuit board 49a of the movable unit 30a, under the condition where the vertical hall element hv10 faces the second position-detecting and driving magnet 412b of the fixed unit 30b, in the third direction z.

The base board 65b is a plate state member which becomes the base for attaching the first position-detecting and driving yoke 431b etc., and is arranged being parallel to the imaging surface of the imaging device 39a1.

In the first embodiment, the base board 65b is arranged at the side nearer to the photographing lens 67 in comparison with the movable circuit board 49a, in the third direction z. However, the movable circuit board 49a may be arranged at the side nearer to the photographing lens 67 in comparison with the base board 65b. In this case, the first and second driving coils 31a and 32a, and the hall element unit 44a are arranged on the opposite side of the movable circuit board 49a to the photographing lens 67, so that the first and second position-detecting and driving magnets 411b and 412b are arranged on the same side of the base board 65b as the photographing lens 67.

The hall-element signal-processing unit 45 detects a horizontal potential-difference x10 between output terminals of the horizontal hall element hh10, based on an output signal of the horizontal hall element hh10.

The hall-element signal-processing unit 45 outputs the first detected-position signal px, which specifies the first location in the first direction x of the movable unit 30a, to the A/D converter A/D 2 of the CPU 21, on the basis of the horizontal potential-difference x10.

The hall-element signal-processing unit 45 detects a vertical potential-difference y10 between output terminals of the vertical hall element hv10, based on an output signal of the vertical hall element hv10.

The hall-element signal-processing unit 45 outputs the second detected-position signal py, which specifies the second location in the second direction y of the movable unit 30a, to the A/D converter A/D 3 of the CPU 21, on the basis of the vertical potential-difference y10.

Next, the indicating operation for the hand-shake quantity, in the anti-shake operation which is performed at every first time-interval, is explained. The indicating unit 17 not only indicates the image which is imaged by the normal imaging operation, but also indicates the value of the hand-shake quantity, or indicates the value of the data for the position S (sx, sy) which should be moved to, corresponding to the hand-shake quantity, as the hand-shake quantity of the photographing apparatus 1. The indicating operation for the indicating unit 17, is controlled by the CPU 21. In the first embodiment, the value of the data for the position S (sx, sy) which should be moved to, corresponding to the hand-shake quantity, as the hand-shake quantity of the photographing apparatus 1, is indicated on the indicating unit 17.

The value of sx which is defined as the location in the first direction x of the position S, and the value of sy which is defined as the location in the second direction y of the position S, are changed at every first time-interval, where the anti-shake operation is performed.

The value of sx which is calculated for an (n+1)th anti-shake operation, immediately after the anti-shake indicating-mode switch 15a is set to the on state, is defined as an nth horizontal data DatXₙ.

The value of sy which is calculated for an (n+1)th anti-shake operation, immediately after the anti-shake indicating-mode switch 15a is set to the on state, is defined as an nth vertical data DatYₙ.

A parameter, which is used for counting the number of anti-shake operations, is defined as an anti-shake operation-number parameter n. The anti-shake operation-number parameter n is 0 or an integer greater than 0, and the initial value of the anti-shake operation number parameter n is 0, and the value of the anti-shake operation-number parameter n is increased by only 1 in every anti-shake operation for every first time-interval (1 ms).

The time length where the hand-shake indicating-mode switch 15a is in the on state is defined as a first time-length T1.

A parameter, which is used for counting a time length such as the first time-length T1 etc., is defined as a hand-shake indicating-time parameter tt. The hand-shake indicating-time parameter tt is 0 or an integer value greater than 0 and less than a second time-length TTW. The initial value of the hand-shake indicating-time parameter tt is 0, and the value of the hand-shake indicating-time parameter tt is increased by only 1 in every anti-shake operation for every first time-interval (1 ms), until the value of the hand-shake indicating-time parameter tt exceeds the second time-length TTW.

The second time-length TTW is the time range of the first graph Gr1.

When the first anti-shake operation is performed, immediately after the hand-shake indicating-mode switch 15a is set to the on state, the anti-shake operation-number parameter n is set to the initial value 0, and the hand-shake indicating-time parameter tt is set to the initial value 0.

Specifically, the 1st anti-shake operation (n=0) is performed immediately after the anti-shake indicating-mode switch 15a is set to the on state (tt=0). The 2nd anti-shake operation (n=1) is performed 1 ms after the anti-shake indicating-mode switch 15a is set to the on state (tt=1). The 3rd anti-shake operation (n=2) is performed 2 ms after the anti-shake indicating-mode switch 15a is set to the on state (tt=2).

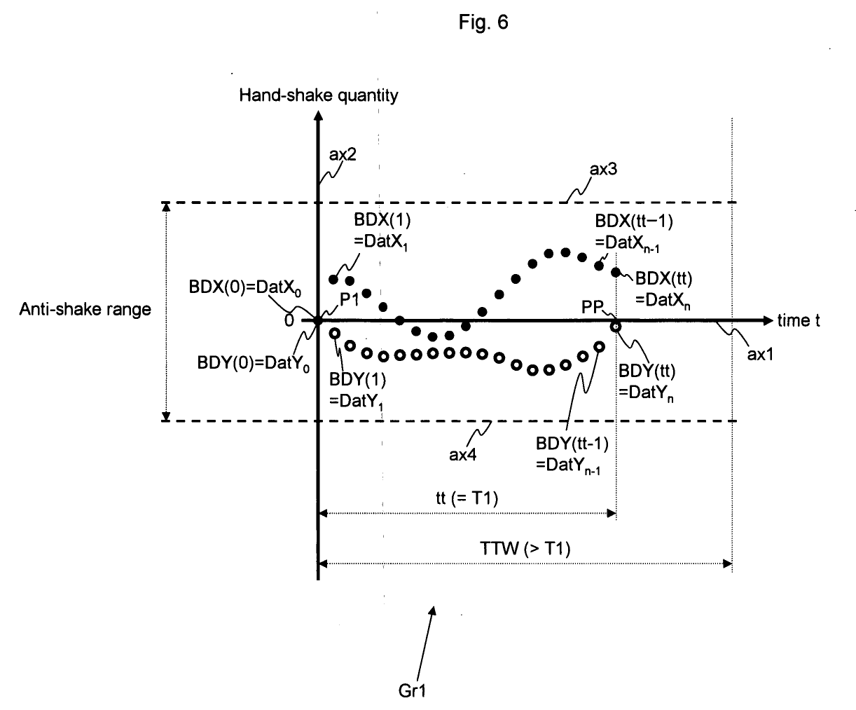

A relationship between the time and the hand-shake quantity of the photographing apparatus 1, is explained by a first graph Gr1 in FIG. 6 etc.

In the first graph Gr1, a horizontal axis ax1 represents a time t, a vertical axis ax2 represents the value of the hand-shake quantity. The first graph Gr1 has the horizontal axis ax1 and the vertical axis ax2, and further has a maximum line ax3 and a minimum line ax4 (see FIGS. 6, 7, and 8). The maximum line ax3 and the minimum line ax4 show a range where the anti-shake operation can be performed by the anti-shake unit 30 etc. The time t is 0 or an integer greater than 0.

The indicating operation for the hand-shake quantity, is performed by plotting values of a first hand-shake data function BDX(t) and a second hand-shake data function BDY(t) on the first graph Gr1.

The first hand-shake data function BDX(t) is a first hand-shake quantity in the first direction x, and is a function of time t.

The second hand-shake data function BDY(t) is a second hand-shake quantity in the second direction y, and is a function of time t.

Plotting is performed by using a figure or a sign to indicate a point on the graph. It is desirable that the form of one of the figure and the sign for plotting the values of the first hand-shake data function BDX(t) is different from the form of one of the figure and the sign for plotting the values of the second hand-shake data function BDY(t), in order to simplify the distinction between the first hand-shake data function BDX(t) and the second hand-shake data function BDY(t) for the operator.

In the first embodiment, plotting the first hand-shake data function BDX(t) is performed using a solid black circle, and plotting the second hand-shake data function BDY(t) is performed using a black o-type circle (see FIGS. 6, 7, and 8).

The first hand-shake data function BDX(t) has first hand-shake quantity values from the first past-point P1 to the present point PP.

The second hand-shake data function BDY(t) has second hand-shake quantity values from the first past-point P1 to the present point PP.

The present point PP is the time point in which the latest anti-shake operation is performed.

The first past-point P1 is a time point in the past which is the first time-length T1 back from the present point PP, in the case that the first time-length T1 is shorter than the second time-length TTW (see FIG. 6).

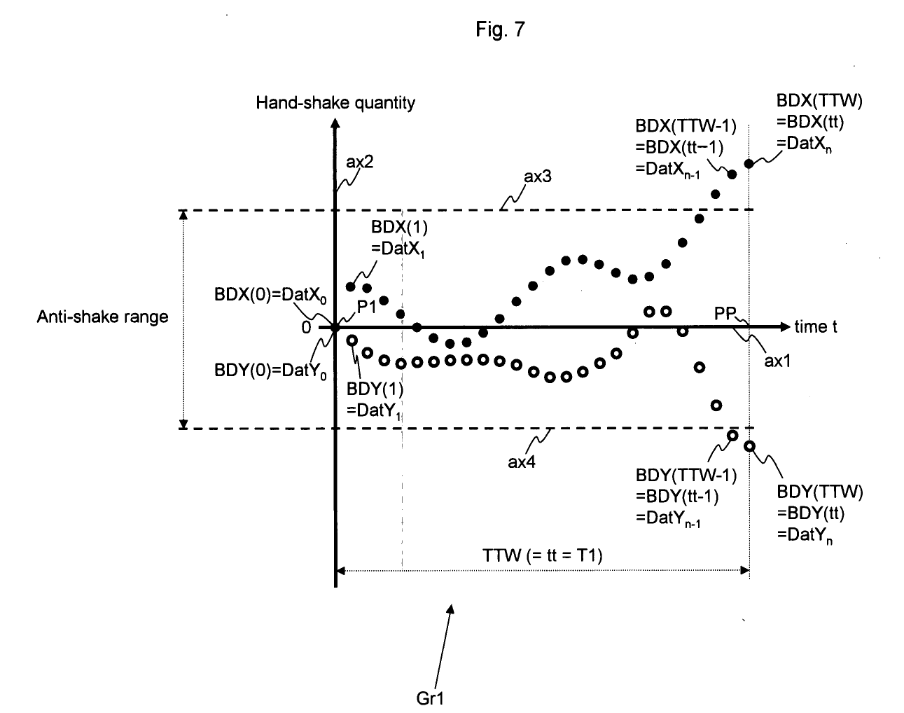

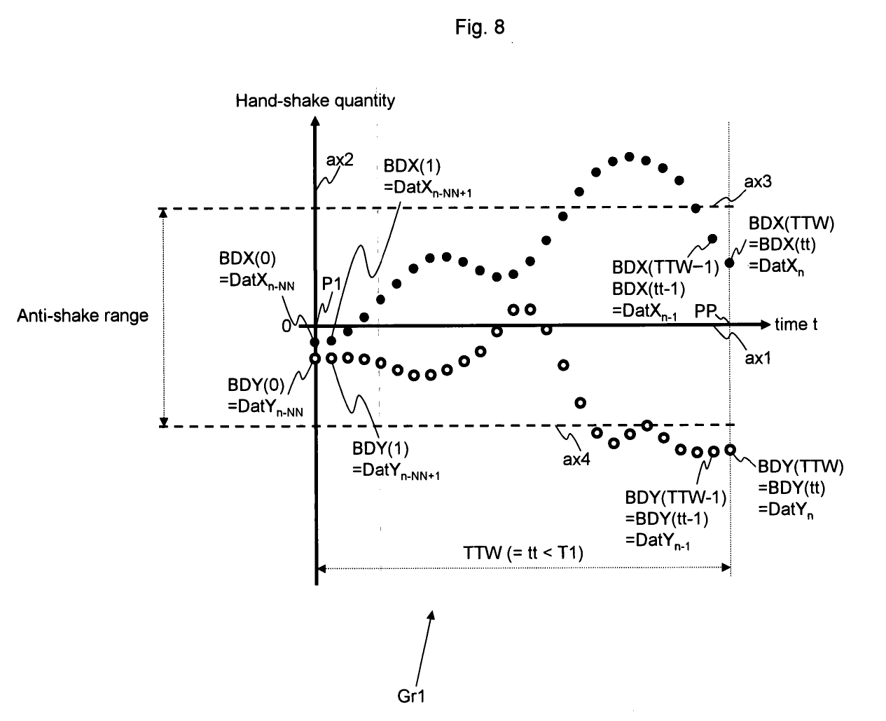

The first past-point P1 is a time point in the past which is the second time-length TTW back from the present point PP, in the case that the first time-length T1 is not shorter than the second time-length TTW (see FIGS. 7 and 8).

Specifically, when the first time-length T1 is shorter than the second time-length TTW, the hand-shake indicating-time parameter tt is shorter than the second time-length TTW and is the same as the first time-length T1. Therefore, when the time t is 0, the value of the first hand-shake data function BDX(t) is set to the 0 horizontal data DatX₀, when the time t is 1, the value of the first hand-shake data function BDX(t) is set to the 1st horizontal data DatX₁, when the time t is tt−1, the value of the first hand-shake data function BDX(t) is set to the (n−1)th horizontal data DatXₙ₋₁, and when the time t is tt, the value of the first hand-shake data function BDX(t) is set to the nth horizontal data DatXₙ (see FIG. 6).

Similarly, when the time t is 0, the value of the second hand-shake data function BDY(t) is set to the 0 vertical data DatY₀, when the time t is 1, the value of the second hand-shake data function BDY(t) is set to the 1st vertical data DatY₁, when the time t is tt−1, the value of the second hand-shake data function BDY(t) is set to the (n−1)th vertical data DatYₙ₋₁, and when the time t is tt, the value of the second hand-shake data function BDY(t) is set to the nth vertical data parameter DatYₙ.

The time range of the first hand-shake data function BDX(t) (the second hand-shake data function BDY(t)) is the same as the first time-length T1, from the first past-point P1 (t=0), until the present point PP (t=tt), or from when the hand-shake indicating-mode is started, until the present time. The number of data in each of the first and second hand-shake data functions BDX(t) and BDY(t), is n+1.

On the first graph Gr1, the values of the first and second hand-shake data functions BDX(t) and BDY(t) are plotted, from when the time t is 0, until the time t is tt (see FIG. 6).

In FIG. 6, all of the values of the first and second hand-shake data functions BDX(t) and BDY(t) are under the value of the maximum line ax3, and above the value of the minimum line ax4. Or, the first and second hand-shake quantities are in the anti-shake range of the anti-shake unit 30 etc., from when the time t is 0, until the time t is tt. In this case, the hand-shake situation can be canceled by the anti-shake operation of the anti-shake unit 30 etc.

Next, when the first time-length T1 is the same as the second time-length TTW, the hand-shake indicating-time parameter tt is the same as the second time-length TTW and is the same as the first time-length T1. Therefore, when the time t is 0, the value of the first hand-shake data function BDX(t) is set to the 0 horizontal data DatX₀, when the time t is 1, the value of the first hand-shake data function BDX(t) is set to the 1st horizontal data DatX₁, when the time t is tt−1 and is TTW−1, the value of the first hand-shake data function BDX(t) is set to the (n−1)th horizontal data DatXₙ₋₁, and when the time t is tt and TTW, the value of the first hand-shake data function BDX(t) is set to the nth horizontal data parameter DatXₙ (see FIG. 7).

Similarly, when the time t is 0, the value of the second hand-shake data function BDY(t) is set to the 0 vertical data DatY₀, when the time t is 1, the value of the second hand-shake data function BDY(t) is set to the 1st vertical data DatY₁, when the time t is tt−1 and is TTW−1, the value of the second hand-shake data function BDY(t) is set to the (n−1)th vertical data DatYₙ₋₁, and when the time t is tt and TTW, the value of the second hand-shake data function BDY(t) is set to the nth vertical data parameter DatYₙ.

The time range of the first hand-shake data function BDX(t) (the second hand-shake data function BDY(t)) is the same as the first time-length T1 and the second time-length TTW, from the first past-point P1 (t=0), until the present point PP (t=tt=TTW), or from when the hand-shake indicating-mode is started, until the present time.

Further, an anti-shake operation-number NN is defined where the (NN+1)th anti-shake operation is performed immediately after the first time-length T1 reaches the second time-length TTW. The value of the anti-shake operation-number parameter n is larger than the anti-shake operation-number NN, the value of the hand-shake indicating-time parameter tt is kept the same as the second time-length TTW.

The number of data which first and second hand-shake data functions BDX(t) and BDY(t) have, is respectively n+1 (NN+1).

On the first graph Gr1, the values of the first and second hand-shake data functions BDX(t) and BDY(t) are plotted, from when the time t is 0, until the time t is tt (TTW) (see FIG. 7).

In FIG. 7, the value of the first hand-shake data function BDX(t) is over the value of the maximum line ax3, when the time t is tt (TTW), and the value of the second hand-shake data function BDY(t) is under the value of the minimum line ax4, when the time t is tt (TTW).

Or, the first and second hand-shake quantities are not in the anti-shake range of the anti-shake unit 30 etc. In this case, the hand-shake situation can not be canceled by the anti-shake operation of the anti-shake unit 30 etc.

Further, the first graph Gr1 in FIG. 7 shows that the values of the first and second hand-shake quantities are increasing from a time point in the past which is traced back from the present point PP (t=tt=TTW).

Next, when the first time-length T1 is longer than the second time-length TTW, the hand-shake indicating-time parameter tt is kept the same as the second time-length TTW. Therefore, when the time t is 0, the value of the first hand-shake data function BDX(t) is set to the (n−NN)th horizontal data DatX_{n-NN}. When the time t is 1, the value of the first hand-shake data function BDX(t) is set to the (n−NN+1)th horizontal data DatX_{n-NN+1}. When the time t is tt−1 and is TTW−1, the value of the first hand-shake data function BDX(t) is set to the (n−1)th horizontal data DatXₙ₋₁. And when the time t is tt and TTW, the value of the first hand-shake data function BDX(t) is set to the nth horizontal data parameter DatXₙ (see FIG. 8).

Similarly, when the time t is 0, the value of the second hand-shake data function BDY(t) is set to the (n−NN)th vertical data DatY_{n-NN}. When the time t is 1, the value of the second hand-shake data function BDY(t) is set to the (n−NN+1)th vertical data DatY_{n-NN+1}. When the time t is tt−1 and is TTW−1, the value of the second hand-shake data function BDY(t) is set to the (n−1)th vertical data DatYₙ₋₁. And when the time t is tt and TTW, the value of the second hand-shake data function BDY(t) is set to the nth vertical data parameter DatYₙ.

The time range of the first hand-shake data function BDX(t) (the second hand-shake data function BDY(t)) is the same as the second time-length TTW, from the first past-point P1 (t=0), until the present point PP (t=TTW).

The number of data which first and second hand-shake data functions BDX(t) and BDY(t) have, is NN+1.

On the first graph Gr1, the values of the first and second hand-shake data functions BDX(t) and BDY(t) are plotted, from when the time t is 0, until the time t is tt (TTW) (see FIG. 8).

In the anti-shake operation which is performed at every first time-interval (1 ms), the indicating operation for the hand-shake quantity is performed at every first time-interval (1 ms). Therefore, the first graph Gr1 is renewed at every first time-interval (1 ms), and the progress of the first and second hand-shake quantities is independently indicated according to time.

In FIG. 8, when the time t is tt (TTW), the value of the first hand-shake data function BDX(t) is under the value of the maximum line ax3, and above the value of the minimum line ax4, so that the value of the second hand-shake data function BDY(t) is under the value of the minimum line ax4.

That is, the first hand-shake quantity is in the anti-shake range of the anti-shake unit 30 etc., however the second hand-shake quantity is not in the anti-shake range of the anti-shake unit 30 etc. In this case, the hand-shake situation in the first direction x can be canceled by the anti-shake operation of the anti-shake unit 30 etc., however the hand-shake situation in the second direction y can not be canceled by the anti-shake operation of the anti-shake unit 30 etc.

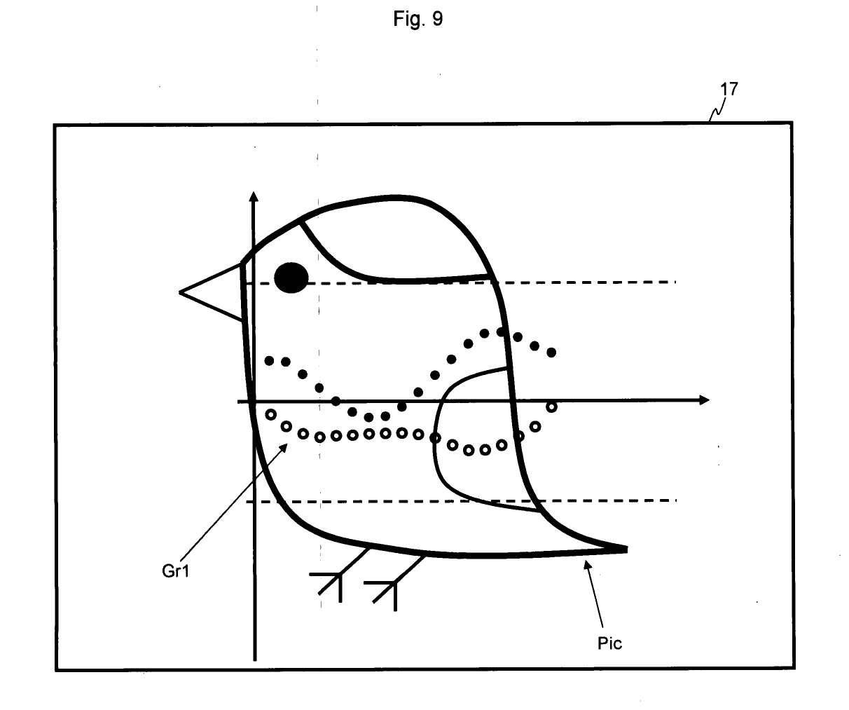

The first graph Gr1 which shows the first and second hand-shake quantities, is indicated and layered on the image Pic which is imaged by the imaging block 22 (the photographing apparatus 1) and is indicated on the indicating unit 17 (see FIG. 9).

Therefore, the operator can confirm the hand-shake quantity while watching the image (the through image) which is imaged by the imaging block 22 (the photographing apparatus 1).

Further, the first graph Gr1 is composed of the horizontal axis ax1, the vertical axis ax2, the maximum line ax3, the minimum line ax4, the first hand-shake data function BDX(t), and the second hand-shake data function BDY(t). The horizontal axis ax1, the vertical axis ax2, the maximum line ax3, and the minimum line ax4 are composed of lines. The first and second hand-shake data functions BDX(t) and BDY(t) are composed of figures or signs. Accordingly, the first graph Gr1 does not obscure most of the image Pic. Therefore, the normal imaging operation, such as confirming the composition, is not interfered with by the first graph Gr1. Further, an additional area which is used for indicating the first graph Gr1, is not needed in addition to the indicating unit 17 which indicates the images.

Further, the operator can confirm whether the first and second hand-shake quantities are in the anti-shake range of the anti-shake unit 30 etc., by indicating the maximum line ax3 and the minimum line ax4 on the first graph Gr1.

In the case that the hand-shake quantity is not divided into the component for the first direction x (the first hand-shake quantity) and the component for the second direction y (the second hand-shake quantity), and a value such as (sx²+sy²)^{1/2}, is indicated, the operator can not recognize which is the larger between the first and second hand-shake quantities, so that the operator can not take effective countermeasures against the hand-shake situation.

In the first embodiment, the hand-shake quantity is indicated where the component for the first direction x (the first hand-shake quantity) and the component for the second direction y (the second hand-shake quantity) are divided. Accordingly, countermeasures corresponding to the direction of the hand-shake, can be taken, for example, when the first hand-shake quantity is larger than the second hand-shake quantity, the operator hold the photographing apparatus 1 in a manner where the first hand-shake quantity can be restrained.

Further, the operator can recognize whether the first and second hand-shake quantities are in the anti-shake range of the anti-shake unit 30 etc., therefore, the operator may take the countermeasures corresponding to the direction of the hand-shake, only when the first or second hand-shake quantity is not in the anti-shake range of the anti-shake unit 30a etc.

Further, only the hand-shake quantity at the present point PP when the latest anti-shake operation is performed, may be indicated. However, in the case where the hand-shake quantity is indicated according to time, the tendency of the hand-shake quantity can be recognized, so that it is easily judged whether the hand-shake quantity is in the anti-shake range of the anti-shake unit 30 etc.

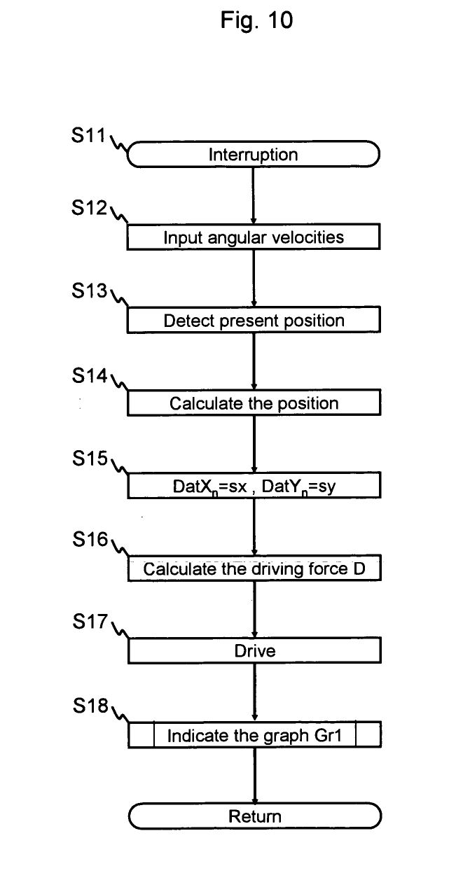

Next, the flow of the anti-shake operation, which is performed at every first time-interval (1 ms) as an interruption process, independently of the other operations, is explained by using the flowchart in FIG. 10.

In step S11, the interruption process for the anti-shake operation is started. In step S12, the first angular velocity vx, which is output from the angular velocity detecting unit 25, is input to the A/D converter A/D 0 of the CPU 21 and is converted to a digital signal. The second angular velocity vy, which is output from the angular velocity detecting unit 25, is input to the A/D converter A/D 1 of the CPU 21 and is converted to a digital signal.

In step S13, the position of the movable unit 30a is detected by the hall element unit 44a, so that the first detected-position signal px, which is calculated by the hall-element signal-processing unit 45, is input to the A/D converter A/D 2 of the CPU 21 and is converted to a digital signal (pdx), and the second detected-position signal py, which is calculated by the hall-element signal-processing unit 45, is input to the A/D converter A/D 3 of the CPU 21 and is converted to a digital signal (pdy). Therefore, the present position of the movable unit 30a P (pdx, pdy) is determined.

In step S14, the position S (sx, sy) of the movable unit 30a (the imaging unit 39a), which should be moved to, is calculated on the basis of the first and second angular velocities vx and vy.

In step S15, the value of the nth horizontal data DatXₙ is set to the value of sx which is the component in the first direction x of the position S which should be moved to and is calculated in step S14. Similarly, the value of the nth vertical data DatYₙ is set to the value of sy which is the component in the second direction y of the position S which should be moved to and is determined in step S14.

In step S16, the driving force D, which drives the driver circuit 29 in order to move the movable unit 30a to the position S, in other words the first PWM duty dx and the second PWM duty dy, is calculated on the basis of the position S (sx, sy), which is determined in step S14, and the present position P (pdx, pdy).

In step S17, the first driving coil unit 31a is driven by using the first PWM duty dx through the driver circuit 29, and the second driving coil unit 32a is driven by using the second PWM duty dy through the driver circuit 29, so that the movable unit 30a is moved.

The process in steps S16 and S17 is an automatic control calculation, which is used with the PID automatic control for performing general (normal) proportional, integral, and differential calculations.

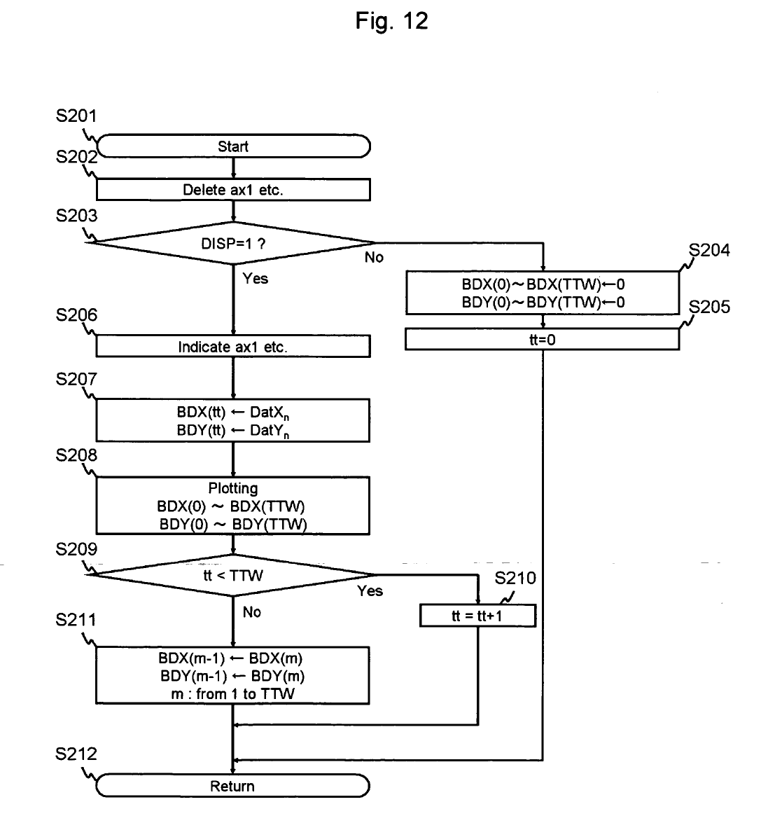

In step S18, the first graph Gr1 is indicated, in the case where the value of the parameter DISP is 1. The details of the indication of the first graph Gr1 are described later with FIG. 12.

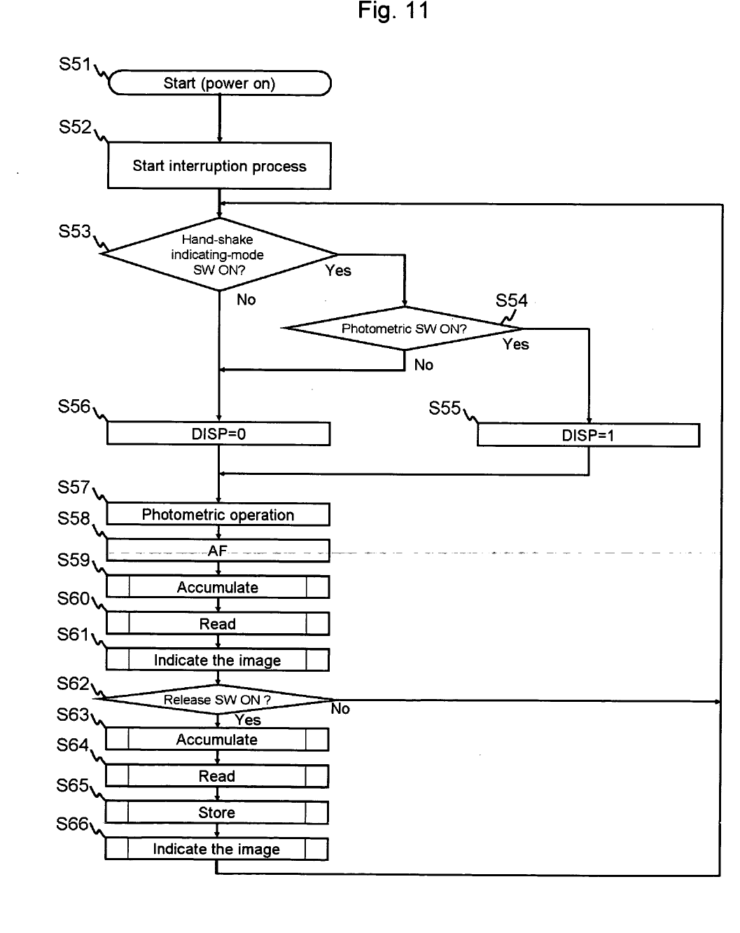

Next, the flow of the imaging operation is explained by using the flowchart in FIG. 11.

In step S51, the Pon switch 11a is set to the on state (power on), so that the power of the photographing apparatus 1 is set to the on state. In step S52, the anti-shake operation, which is described by using the flowchart in FIG. 10, is started at every first time-interval (1 ms) as an interruption process. The anti-shake operation is performed independently of the other operations after step S52.

In step S53, it is judged whether the hand-shake indicating-mode switch 15a is in the on state. When it is judged that the hand-shake indicating-mode switch 15a is in the on state in step S53, it is judged whether the photometric switch 12a is in the on state, in step S54. When it is judged that the photometric switch 12a is in the on state in step S54, the value of the parameter DISP is set to 1, in step S55. When it is judged that the hand-shake indicating-mode switch 15a is not in the on state in step S53, or that the photometric switch 12a is not in the on state, the value of the parameter DISP is set to 0, in step S56.

In step S57, the photometric operation is performed by driving an AE sensor of the AE unit 23, so that the aperture value and the time length of the exposure time are calculated. In step S58, the AF sensing operation is performed by driving an AF sensor of the AF unit 24, so that the focusing operation is performed by driving a lens control circuit of the AF unit 24.

In step S59, the electric charge is accumulated in the imaging device 39a1. In step S60, the electric charge, which is accumulated in the imaging device 39a1 in the exposure time, is read.

In step S61, the image on the basis of the electric charge is indicated on the indicating unit 17.

In step S62, it is judged whether the release switch 13a is set to the on state by the operator. When the release switch 13a is not set to the on state, the process is returned to step S53, so that the imaging operation is repeated. When the release switch 13a is set to the on state, the electric charge is accumulated in the imaging device in step S63. In step S64, the electric charge, which is accumulated in the imaging device 39a1, is read. In step S65, the electric charge, which is read, is stored in a memory in the photographing-apparatus 1, as an image which is imaged. In step S66, the image which is stored, is indicated on the indicating unit 17.

After indicating, the process is returned to step S53, so that the imaging operation is repeated.

Next, the flow (the subroutine) of the indication process of the first graph Gr1 is explained by using the flowchart in FIG. 12.

In step S201, the flow of the indication of the first graph Gr1 is started. In step S202, the horizontal axis ax1, the vertical axis ax2, the indication of the maximum line ax3, the minimum line ax4, the first hand-shake data function BDX(t), and the second hand-shake data function BDY(t), are deleted.

Indicating the first graph Gr1 is a part of the anti-shake operation which is performed at every first time-interval (1 ms), so that indicating the first graph Gr1 is performed at every first time-interval (1 ms) (which is sufficiently fast). Accordingly, even if the first graph Gr1 is indicated, after simultaneous deletion of the horizontal axis ax1, the vertical axis ax2, the maximum line ax3, the minimum line ax4, the first hand-shake data function BDX(t), and the second hand-shake data function BDY(t), flickering does not occur.

Further, the value of the hand-shake indicating-time parameter tt is set to 0, immediately after the Pon switch 11a is set to the on state (power on), and before the first anti-shake operation is interrupted and performed.

In step S203, it is judged whether the value of the parameter DISP is 1. When the value of the parameter DISP is not 1, the process is forwarded to step S204. When the value of the parameter DISP is 1, the process is forwarded to step S206.

In step S204, all values of the first hand-shake data function BDX(t), and all values of the second hand-shake data function BDY(t) are deleted. Or, the values of the first hand-shake data function BDX(0) to BDX(TTW) are set to 0, so that the values of the second hand-shake data function BDY(0) to BDY(TTW) are set to 0.

In step S205, the value of the hand-shake indicating-time parameter tt is deleted. Or, the value of the hand-shake indicating-time parameter tt is set to 0.

In step S206, the horizontal line ax1, the vertical line ax2, the maximum line ax3, and the minimum line ax4 are indicated on the indicating unit 17. On the indicating unit 17, the image Pic which is imaged by the imaging block 22 (the photographing apparatus 1), is indicated, therefore, the horizontal line ax1, the vertical line ax2, the maximum line ax3, and the minimum line ax4 are layered and indicated on the image Pic.

In step S207, the value of the first hand-shake data function BDX(tt) corresponding to the hand-shake indicating-time parameter tt, is set to the nth horizontal data DatXₙ, and the value of the second hand-shake data function BDY(tt) corresponding to the hand-shake indicating-time parameter tt, is set to the nth vertical data DatYₙ.

In step S208, the indicating operation for the hand-shake quantity, is performed by plotting values of a first hand-shake data function BDX(t) and a second hand-shake data function BDY(t) on the first graph Gr1 on the indicating unit 17.

In step S209, it is judged whether the value of the hand-shake indicating-time parameter tt is smaller than the second time-length TTW. When the value of the hand-shake indicating-time parameter tt is smaller than the second time-length TTW, the value of the hand-shake indicating-time parameter tt is increased by 1, in order to plot the values of the first hand-shake quantity (the first hand-shake data function BDX(t)) and of the second hand-shake quantity (the second hand-shake data function BDY(t)), for the next 1 ms, in step S210.

When the value of the hand-shake indicating-time parameter tt is not smaller than the second time-length TTW, the process is forwarded to step S211.

In step S211, re-inputting of the data is performed. Or the values of the first hand-shake data function BDX(t) while the time t is from 1 to TTW, is changed for the values of the first hand-shake data function BDX(t) while the time t is from 0 to TTW−1. In other words, the plotted values of the first hand-shake data function BDX(t) are moved to left side in the first direction x and are re-indicated on the first graph Gr1 on the indicating unit 17.

Similarly, the values of the second hand-shake data function BDY(t) while the time t is from 1 to TTW, is changed for the values of the second hand-shake data function BDY (t) while the time t is from 0 to TTW−1. In other words, the plotted values of the second hand-shake data function BDY(t) are moved to left side in the first direction x and are re-indicated on the first graph Gr1 on the indicating unit 17.

That is to say, the hand-shake quantity data for the present time, is changed for the hand-shake quantity data obtained for the first time-interval (1 ms) before the present time. The value of the hand-shake indicating-time parameter tt is not changed.

Specifically, the first hand-shake data function BDX(m) when the time t is a parameter m, is changed for the first hand-shake data function BDX(m−1). The parameter m is set to the value from 1 to TTW (1≦m≦TTW). The re-inputting of data is performed repeatedly when changing the value of the parameter m from 1 to TTW. Similarly, the second hand-shake data function BDY(m) when the time t is the parameter m, is changed for the second hand-shake data function BDY(m−1).

For example, the value of the first hand-shake data function BDX(t) when the time t is TTW, is changed for the value of the first hand-shake data function BDX(t) when the time t is TTW−1. Similarly, the value of the first hand-shake data function BDX(t) when the time t is TTW−1, is changed for the value of the first hand-shake data function BDX(t) when the time t is TTW−2.

In step S212, the flow (the subroutine) of the indication of the first graph Gr1 is finished.

Next, the second embodiment is explained. In the second embodiment, a second graph Gr2 is indicated on the indicating unit 17, instead of the first graph Gr1 in the first embodiment.

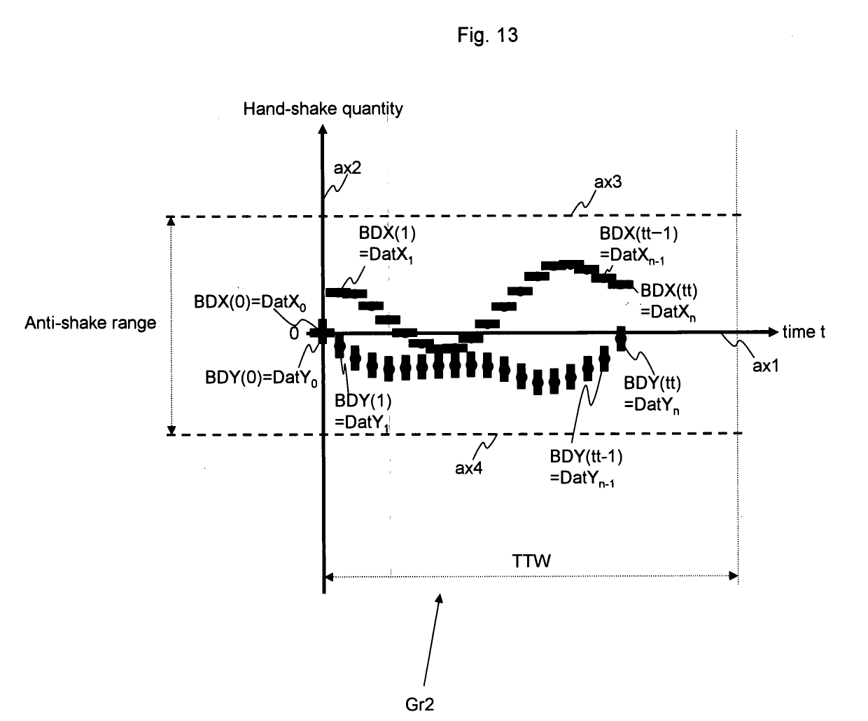

A figure which is used for plotting the first and second hand-shake data functions BDX(t) and BDY(t) on the second graph Gr2 in the second embodiment is different from the figure which is used for plotting the first and second hand-shake data functions BDX(t) and BDY(t) on the first graph Gr1 in the first embodiment (see FIG. 13).

Specifically, a character form of the figure which is used for plotting the first and second hand-shake data functions BDX(t) and BDY(t) on the second graph Gr2 is set to rectangular, in the second embodiment. The character form of the figure which is used for plotting the first and second hand-shake data functions BDX(t) and BDY(t) on the first graph Gr1 is set to circular, in the first embodiment.

Further, the character form of the figure which is used for plotting the first hand-shake data function BDX(t) on the second graph Gr2, is set to a rectangle whose long sides are parallel to the first direction x, so that the character form of the figure which is used for plotting the second hand-shake data function BDY(t) on the second graph Gr2 is set to a rectangle whose long sides are parallel to the second direction y.

The other constructions of the photographing apparatus 1 in the second embodiment are the same as those in the first embodiment.

In the second embodiment, it becomes easy to distinguish the first hand-shake data function BDX(t) and the second hand-shake data function BDY(t) which are plotted on the second graph Gr2.

Further, in the second embodiment, the second graph Gr2 is also indicated and layered on the image Pic which is imaged by the imaging block 22 (the photographing apparatus 1) and is indicated on the indicating unit 17, such as FIG. 9 in the first embodiment.

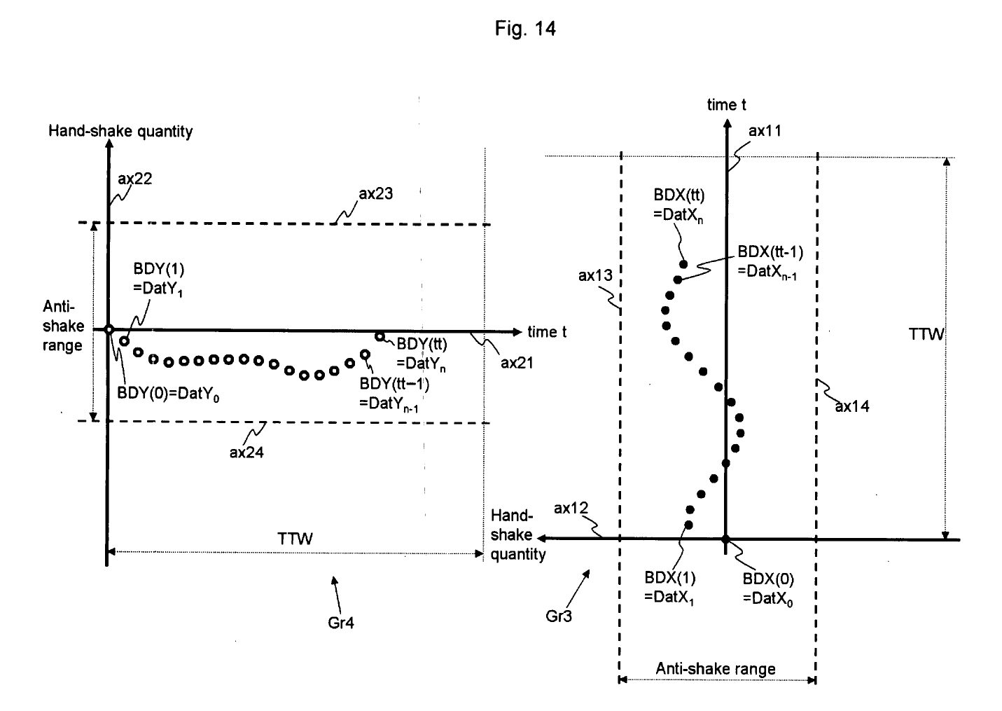

Next, the third embodiment is explained. In the third embodiment, two graphs (third and fourth graphs Gr3 and Gr4) are indicated on the indicating unit 17 (see FIG. 14).

Plotting the first hand-shake data function BDX(t) is performed on the third graph Gr3, so that plotting the second hand-shake data function BDY(t) is performed on the fourth graph Gr4.

In the third graph Gr3, a vertical axis ax11 represents a time t, a horizontal axis ax12 represents the value of the hand-shake quantity (the first hand-shake quantity). The third graph Gr3 has the vertical axis ax11 and the horizontal axis ax12, and further has a maximum line ax13 and a minimum line ax14 (see FIG. 14). The maximum line ax13 and the minimum line ax14 show a range where the anti-shake operation in the first direction x can be performed by the anti-shake unit 30 etc.

In the fourth graph Gr4, a horizontal axis ax21 represents a time t, a vertical axis ax22 represents the value of the hand-shake quantity (the second hand-shake quantity). The fourth graph Gr4 has the horizontal axis ax21, and the vertical axis ax22, and further has a maximum line ax23 and a minimum line ax14 (see FIG. 14). The maximum line ax23 and the minimum line ax24 show a range where the anti-shake operation in the second direction y can be performed by the anti-shake unit 30 etc.

Accordingly, the vertical line ax11 which represents a time t, is perpendicular to the horizontal line ax21 which represents a time t. Similarly, the horizontal line ax12 which represents the first hand-shake quantity, is perpendicular to the vertical line ax22 which represents the second hand-shake quantity.

Therefore, values of the first hand-shake data function BDX(t) are plotted on the third graph Gr3, where a coordinate transformation is performed in accordance with the vertical axis ax11 and the horizontal axis ax12.

The other constructions of the photographing apparatus 1 in the third embodiment are the same as those in the first embodiment.

The hand-shake quantity in the first direction x (the first hand-shake quantity) and the hand-shake quantity in the second direction y (the second hand-shake quantity) are indicated on each graph independently. Accordingly, it becomes easy to distinguish the first hand-shake data function BDX(t) which is plotted on the third graph Gr3 and the second hand-shake data function BDY(t) which are plotted on the fourth graph Gr4.

Further, a direction in which the first hand-shake quantity is measured agrees with a direction of the vertical axis ax12, which shows the first hand-shake quantity. Similarly, a direction in which the second hand-shake quantity is measured agrees with a direction of the horizontal axis ax22, which shows the second hand-shake quantity. Accordingly, it becomes easy to recognize the direction of the hand-shake and the hand-shake quantity, visually.

Further, in the third embodiment, the third and fourth graphs Gr3 and Gr4 are also indicated and layered on the image Pic which is imaged by the imaging block 22 (the photographing apparatus 1) and are indicated on the indicating unit 17, such as FIG. 9 in the first embodiment.

In the first, second and third embodiments, it is explained that the position-detecting operation is performed by using the hall element and the magnet. However, the position-detecting operation may be performed by using another apparatus.

Further, it is explained that the moving operation of the movable unit is performed by using the coil and magnet. However, the moving operation of the movable unit may be performed by using another apparatus.

Further, it is explained that the anti-shake operation is performed by the anti-shake unit 30 etc. However, the photographing apparatus may have only an indicating function of the hand-shake quantity, without an anti-shake (hand-shake correcting) function. In this case, the effect for easily recognizing the hand-shake quantities divided into two dimensions, can be obtained. In this case, the maximum line such as ax3, and the minimum line such as ax4 are not needed.

Further, it is explained that the graph such as the first graph Gr1 is layered and indicated on the image Pic on the same indicating unit 17. However, the graph may be indicated on another indicating unit independently.

Further, it is explained that the movable unit 30a has the imaging device 39a1. However, the movable unit 30a may have a hand-shake correcting lens instead of the imaging device.

Further, it is explained that the hall element is used for position-detecting as the magnetic-field change-detecting element, however, another detecting element may be used for position-detecting. Specifically, the detecting element may be an MI (Magnetic Impedance) sensor, in other words a high-frequency carrier-type magnetic-field sensor, or a magnetic resonance-type magnetic-field detecting element, or an MR (Magneto-Resistance effect) element. When one of the MI sensor, the magnetic resonance-type magnetic-field detecting element, and the MR element is used, the information regarding the position of the movable unit can be obtained by detecting the magnetic-field change, similar to using the hall element.

Further, it is explained that the photographing apparatus 1 such as a digital camera, has the detecting unit (the angular velocity detecting unit 25) and the indicating unit (the indicating unit 17). However, another portable apparatus such as binoculars and a photographing apparatus other than the digital camera, may have the detecting unit (the angular velocity detecting unit 25) and the indicating unit (the indicating unit 17).

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2004-097837 (filed on Mar. 30, 2004), which is expressly incorporated herein by reference, in its entirety.

1. A photographing apparatus, comprising:
a detecting unit which performs a detecting operation to detect a first quantity of a hand-shake of said photographing apparatus in a first direction being perpendicular to an optical axis of a photographing lens of said photographing apparatus, and to detect a second quantity of said hand-shake in a second direction being perpendicular to said optical axis and said first direction; and
an indicating unit which performs an indicating operation to indicate said first and second quantities.

2. The photographing apparatus according to claim 1, wherein said detecting unit has a hand-shake quantity detecting unit and a calculating unit;
said hand-shake quantity detecting unit detects a first signal regarding said hand-shake in said first direction and a second signal regarding said hand-shake in said second direction, and outputs said first and second signals; and
said calculating unit calculates said first quantity on the basis of said first signal, and calculates said second quantity on the basis of said second signal.

3. The photographing apparatus according to claim 2, wherein said hand-shake quantity detecting unit has first and second angular velocity sensors and a filter circuit;
said first angular velocity sensor detects a first velocity-component in said first direction of an angular velocity of said photographing apparatus;
said second angular velocity sensor detects a second velocity-component in said second direction of said angular velocity; and
said filter circuit outputs a first angular velocity signal which is amplified and has a reduced null voltage and panning for said first velocity-component, as said first signal, and outputs a second angular velocity signal which is amplified and has a reduced null voltage and panning for said second velocity-component, as said second signal.

4. The photographing apparatus according to claim 1, wherein said detecting operation and said indicating operation are performed at every first time-interval.

5. The photographing apparatus according to claim 4, wherein said first time-interval is 1 ms.

6. The photographing apparatus according to claim 4, wherein said indicating unit indicates said first and second quantities according to time.

7. The photographing apparatus according to claim 6, wherein said indicating operation indicating said first and second quantities according to time is performed by plotting values of said first and second quantities changed in accordance with said first time-interval, on a graph;
said graph has a first axis being parallel to said first direction and a second axis being parallel to said second direction; and
one of said first and second axes represents time, and another of said first and second axes represents the value of the hand-shake quantity.

8. The photographing apparatus according to claim 7, wherein, the values of said first and second quantities from a first past-point until a present point are plotted on said graph;
said present point is a time point at which the latest said detecting operation is performed;
said first past-point is a time point in the past which is a predetermined time-length back from said present point.

9. The photographing apparatus according to claim 8, wherein said predetermined time-length is the time range of said graph.

10. The photographing apparatus according to claim 7, wherein the values of said first and second quantities are plotted by using a figure or a sign to indicate a point on said graph;
a form of one of said figure and sign for plotting the values of said first quantity is different from a form of one of said figure and sign for plotting the values of said second quantity.

11. The photographing apparatus according to claim 10, wherein a character form for plotting the values of said first quantity is a rectangle whose long sides are parallel to said first direction, and a character form for plotting the values of said second quantity is a rectangle whose long sides are parallel to said second direction.

12. The photographing apparatus according to claim 7, wherein said indicating operation indicates a first graph and a second graph;
in said first graph, said second axis represents time, and said first axis represents the value of the hand-shake quantity;
in said second graph, said first axis represents time, and said second axis represents the value of the hand-shake quantity;
the values of said first quantity are plotted on said first graph; and
the values of said second quantity are plotted on said second graph.

13. The photographing apparatus according to claim 7, wherein said first axis is a horizontal axis and said second axis is a vertical axis.

14. The photographing apparatus according to claim 1, further comprising an anti-shake apparatus which has one of an imaging device and a hand-shake correcting lens, and corrects said hand-shake by moving one of said imaging device and said hand-shake correcting lens which is included in said anti-shake apparatus, in both said first and second directions.

15. The photographing apparatus according to claim 14, wherein said indicating unit indicates a range of an anti-shake operation by said anti-shake apparatus, in addition to indicating the values of said first and second quantities.

16. The photographing apparatus according to claim 1, wherein the values of said first and second quantities are indicated and layered on an image which is imaged by said photographing apparatus and is indicated on said indicating unit.

17. A portable apparatus, comprising:
a detecting unit which performs a detecting operation to detect a first quantity of a hand-shake of said portable apparatus in a first direction being perpendicular to an optical axis of an optical system of said photographing apparatus, and to detect a second quantity of said hand-shake in a second direction being perpendicular to said optical axis and said first direction; and
an indicating unit which performs an indicating operation to indicate said first and second quantities;
said detecting operation and said indicating operation being performed at every first time-interval;
said indicating operation which indicates said first and second quantities according to time, being performed by plotting values of said first and second quantities changed in accordance with said first time-interval, on a graph;
said graph having a first axis being parallel to said first direction and a second axis being parallel to said second direction; and
one of said first and second axes representing time, and another of said first and second axes representing the value of the hand-shake quantity.
